(19) United States
(12) Patent Application Publication
(10) Pub. No.: US 2022/0169286 A1
(43) Pub. Date: Jun. 2, 2022

(54) TECHNIQUES FOR DETECTING AND PREVENTING VEHICLE WRONG WAY DRIVING

(71) Applicants: Scott L. Radabaugh, Rochester Hills, MI (US); Emily Robb, Troy, MI (US); Philip S. Mallinger, Shelby Township, MI (US); Brian S. Thompson, Ortonville, MI (US); Michael A. Carlson, Davisburg, MI (US)

(72) Inventors: Scott L. Radabaugh, Rochester Hills, MI (US); Emily Robb, Troy, MI (US); Philip S. Mallinger, Shelby Township, MI (US); Brian S. Thompson, Ortonville, MI (US); Michael A. Carlson, Davisburg, MI (US)

(21) Appl. No.: 17/108,194

(22) Filed: Dec. 1, 2020

(51) Int. Cl. B60W 60/00; B60W 40/10; B60W 50/16; B60W 50/12; G01C 21/00; B60W 40/04

(52) U.S. Cl. CPC B60W 60/0018; B60W 40/10; B60W 50/16; B60W 2050/143; G01C 21/3848; B60W 40/04; B60W 50/12

(57) ABSTRACT

Wrong way travel detection and control systems and methods for a vehicle utilize a set of perception sensor systems each configured to perceive a position of the vehicle relative to its environment, a map system configured to maintain map data, and a controller configured to receive first information from the set of perception sensor systems and the map system, generate a confidence score indicative of a likelihood that the vehicle is traveling in a wrong direction along a roadway using a vehicle position model and the received first information, compare the confidence score to a set of one or more thresholds, and based on the comparing, selectively control one or more operating parameters of the vehicle to remedy the wrong direction travel of the vehicle.

### FIELD

The present application generally relates to vehicle autonomous driving features and, more particularly, to techniques for detecting and preventing a vehicle from wrong way driving or driving against legal flow of traffic.

### BACKGROUND

Wrong way driving involves a vehicle traveling along a roadway against the prescribed or legal flow of traffic. One common example of inadvertent wrong way driving is when a vehicle enters a limited access roadway (e.g., a highway) via an exit or off-ramp. Conventional solutions for wrong way driving detection and prevention include detection of signs (e.g., “Wrong Way” or “Do Not Enter”) or flashing lights and/or vehicle-to-device (V2X) communication where a local device (e.g., an installation proximate to an off-ramp) provides the vehicle with information relative to wrong way travel. These conventional solutions may not accurately detect and prevent many wrong way driving scenarios, and also do not account for temporarily acceptable wrong way driving scenarios, such as construction or weather evacuation scenarios. Thus, while such wrong way driving detection systems do work well for their intended purpose, there remains a desire for improvement in the relevant art.

### SUMMARY

According to one example aspect of the invention, a wrong way travel detection and control system for a vehicle is presented. In one exemplary implementation, the system comprises a set of perception sensor systems each configured to perceive a position of the vehicle relative to its environment, a map system configured to maintain map data, and a controller configured to: receive first information from the set of perception sensors and the map system, generate a confidence score indicative of a likelihood that the vehicle is traveling in a wrong direction along a roadway using a vehicle position model and the received first information, compare the confidence score to a set of one or more thresholds, and based on the comparing, selectively control one or more operating parameters of the vehicle to remedy the wrong direction travel of the vehicle.

In some implementations, the controller is further configured to: receive second information from a traffic services system indicative of a traffic or weather evacuation status of the roadway, and generate the confidence score using the vehicle position model and the received first and second information. In some implementations, the vehicle position model is trained to determine an acceptable wrong way driving scenario when the second information indicates temporarily acceptable wrong way travel. In some implementations, the one or more thresholds each correspond to a different level or degree of the control of the one or more operating parameters of the vehicle. In some implementations, the controller is further configured to increase the level or degree of control of the one or more operating parameters of the vehicle while the wrong direction of travel of the vehicle continues.

In some implementations, the one or more operating parameters of the vehicle include (i) at least one of audible, visual, and haptic driver notifications, (ii) at least one of automated steering and braking of the vehicle, and (iii) full shutdown of the vehicle. In some implementations, the set of perception sensors comprises at least one of a global navigation satellite system (GNSS) receiver, a real-time kinematic (RTK) system, an inertial measurement unit (IMU), a camera system, a light detection and ranging (LIDAR) system, and a radio detection and ranging (RADAR) system. In some implementations, the set of perception sensors comprises a GNSS receiver, an RTK system, an IMU, a camera system, a LIDAR system, and a RADAR system.

According to another example aspect of the invention, a wrong way travel detection and control method for a vehicle is presented. In one exemplary implementation, the method comprises receiving, by a controller of the vehicle, first information comprising a perceived position of the vehicle relative to its environment from each of a set of perception sensor systems and map data from and maintained by a map system, generating, by the controller, a confidence score indicative of a likelihood that the vehicle is traveling in a wrong direction along a roadway using a vehicle position model and the received first information, comparing, by the controller, the confidence score to a set of one or more thresholds, and based on the comparing, selectively controlling, by the controller, one or more operating parameters of the vehicle to remedy the wrong direction travel of the vehicle.

In some implementations, the method further comprises receiving, by the controller, second information from a traffic services system indicative of a traffic or weather evacuation status of the roadway, and generating, by the controller, the confidence score using the vehicle position model and the received first and second information. In some implementations, the vehicle position model is trained to determine an acceptable wrong way driving scenario when the second information indicates temporarily acceptable wrong way travel. In some implementations, the one or more thresholds each correspond to a different level or degree of the control of the one or more operating parameters of the vehicle. In some implementations, the method further comprises increasing, by the controller, the level or degree of control of the one or more operating parameters of the vehicle while the wrong direction of travel of the vehicle continues.

In some implementations, the one or more operating parameters of the vehicle include (i) at least one of audible, visual, and haptic driver notifications, (ii) at least one of automated steering and braking of the vehicle, and (iii) full shutdown of the vehicle. In some implementations, the set of perception sensors comprises at least one of a GNSS receiver, an RTK system, an IMU, a camera system, a LIDAR system, and a RADAR system. In some implementations, the set of perception sensors comprises a GNSS receiver, an RTK system, an IMU, a camera system, a LIDAR system, and a RADAR system.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIGS. 1A-1C illustrate example overhead views of Form-Of-Way (FOW) 1, FOW 2, FOW 3, and FOW 10 classified roads where wrong way travel could occur according to the principles of the present disclosure;

FIG. 2 is a functional block diagram of a vehicle having an example wrong way travel detection and control system according to the principles of the present disclosure; and

FIG. 3 is a flow diagram of an example vehicle wrong way travel detection and control method according to the principles of the present disclosure.

### DETAILED DESCRIPTION

As previously discussed, conventional wrong way driving detection systems are insufficient for detecting and preventing many wrong way driving scenarios and are also unable to distinguish temporarily acceptable wrong way driving scenarios. Accordingly, improved vehicle wrong way driving detection and control systems and methods are presented. The techniques employed by these systems and methods utilize high definition (HD) map data and a suite of vehicle perception sensors to model with a high degree of accuracy whether the vehicle is traveling in a wrong direction.

The model generates a confidence score indicative of whether the vehicle is traveling in a wrong direction and, based on a comparison to one or more thresholds, different outputs could be generated (alerts, automated vehicle control, full vehicle shutdown, etc.). Other data sources, such as a traffic services system, could also be leveraged to determine whether a temporarily acceptable wrong way driving scenario is occurring. Non-limiting examples of temporarily acceptable wrong way driving scenarios include construction scenarios and weather evacuation scenarios.

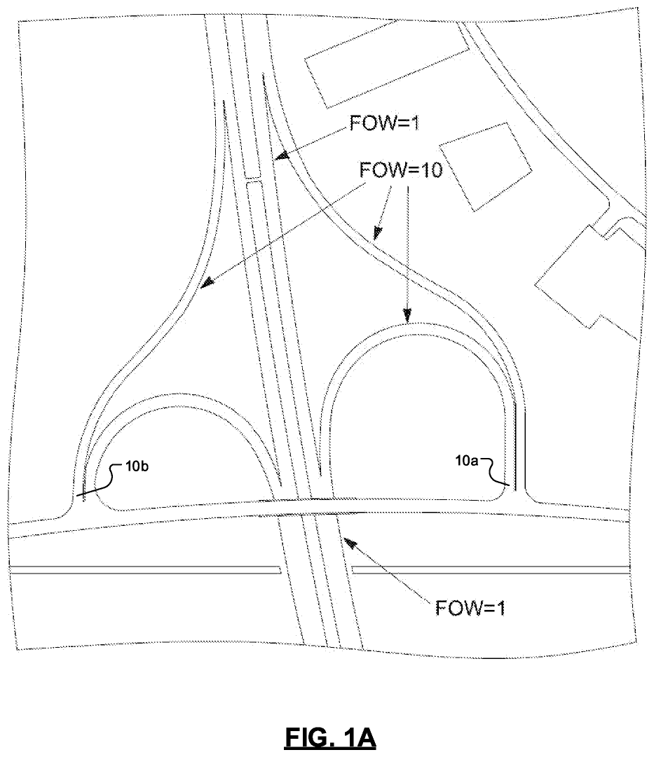

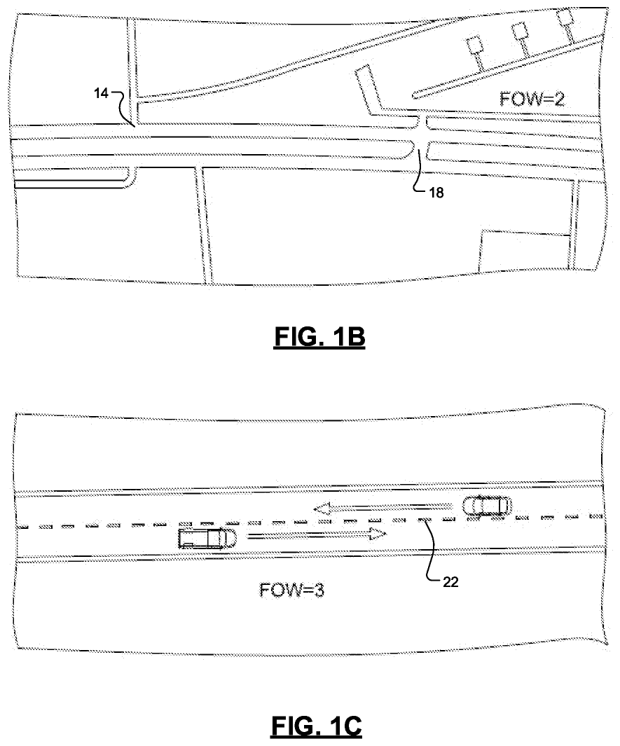

FIGS. 1A-1C illustrates overhead views of example Form of Way (FOW) 1, 2, 9, and 10 classified roads and example wrong way driving scenarios. It will be appreciated that these are merely examples and the various FOW road classifications could have many different appearances. Referring first to FIG. 1A, FOW 1 and FOW 10 classified road portions are illustrated. The FOW 1 road portion is a controlled access freeway or interstate where the road is separated by a physical barrier, where each side of the roadway is digitized separately, and where the driver needs to travel over a defined or controlled access entrance or exit ramp in order to enter or exit the freeway. The FOW 10 road portion is the controlled access entrance and exit ramps of the FOW 1 road portion. References 10a and 10b indicate the exit ramps where a vehicle could inadvertently enter to cause a wrong way driving scenario.

FIG. 1B illustrates a FOW 2 classified road portion where there are two sides of the road that are multiply or separately digitized (e.g., separately stored and identifiable in a map system), some sort of divider therebetween (a physical barrier, a curbed island, a ditch, etc.), and potentially some crossing roads therealong. Reference 14 indicates a side road where a vehicle could inadvertently turn in the wrong direction onto the FOW 2 road causing a wrong way driving scenario. Reference 18 indicates a central turnaround area where a vehicle could inadvertently turn in the wrong direction on the FOW 2 road. Lastly, FIG. 1C illustrates a FOW 3 classified road portion, the best example of which is a typical undivided two-lane road portion. Reference 22 indicates a center lane line that, when crossed over, causes a wrong way driving scenario. As mentioned above, it will be appreciated that these are merely examples of roadways and wrong way driving scenarios and that the techniques of the present disclosure are applicable to any roadways and wrong way driving scenarios.

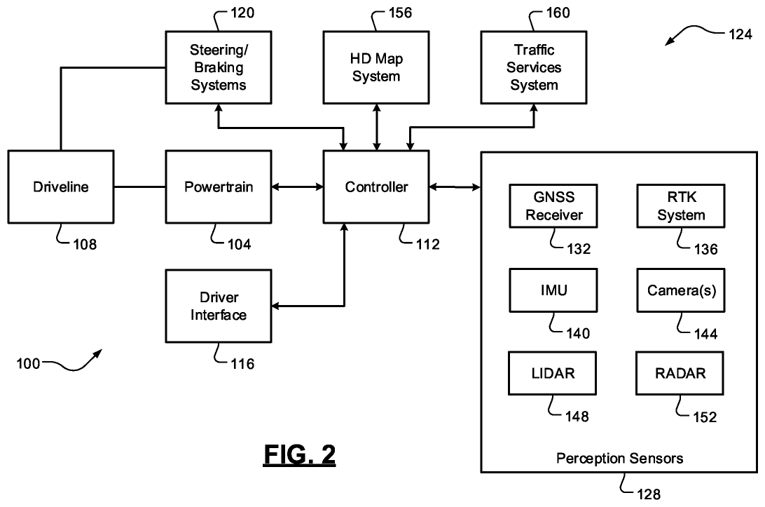

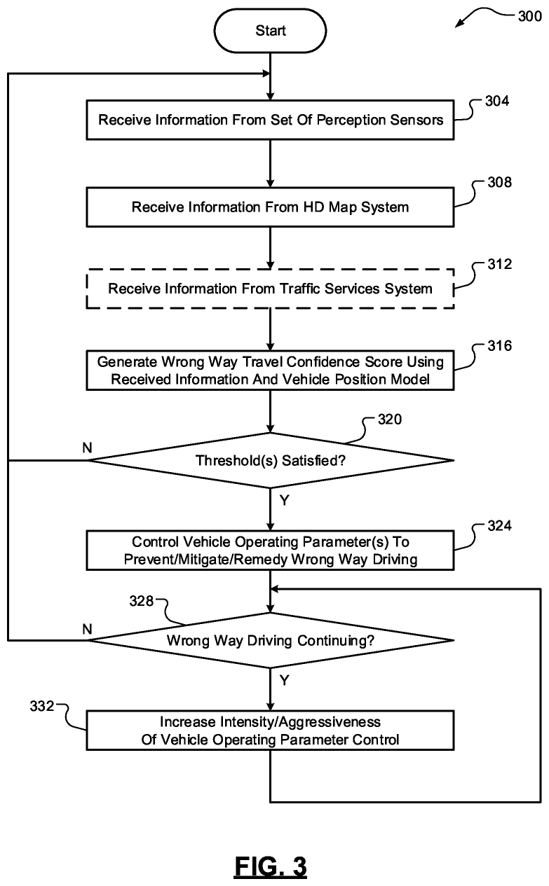

Referring now to FIG. 2, a functional block diagram of an example vehicle 100 having a wrong way detection or travel detection and control system 124 according to the principles of the present disclosure is illustrated. The vehicle 100 comprises a powertrain 104 (e.g., an engine, an electric motor, or combinations thereof) that generates drive torque that is transferred to a driveline 108 for vehicle propulsion. A controller 112 controls operation of the vehicle 100, including, but not limited to, controlling the powertrain 104 to generate a desired amount of drive torque (e.g., based on driver input via a driver interface 116, such as an accelerator pedal). The controller 112 is also configured to perform at least some autonomous driving features, including, but not limited to, wrong way driving detection and control or mitigation, such as audible/visual/haptic driver notifications, automated steering/braking, and/or full-vehicle shutdown (e.g., safe powertrain disablement at vehicle stop).

It will be appreciated that the term “autonomous” as used herein refers to both driver take-over features (e.g., advanced driver assistance features, or ADAS) as well as semi-autonomous and fully-autonomous (e.g., level 4, or L4) modes. For purposes of the present disclosure, the wrong way driving detection and control system 124 of the vehicle 100 generally comprises the controller 112, the steering/braking systems 120, a plurality of perception sensors 128 (also referred to herein as a “suite of perception sensors” or a “perception sensor suite”), an HD map system 156, and a traffic services system 160. The plurality of perception sensors 128 could include, for example, a global navigation satellite system (GNSS) receiver 132, which could also communicate via a network (not shown), an RTK system 136, an IMU 140, one or more cameras 144, a light detection and ranging (LIDAR) system 148, and a radio detection and ranging (RADAR) system 152.

In one exemplary implementation, the GNSS receiver 132 receives a signal indicative of a position of the vehicle 100, which is then precision enhanced based on information from the RTK system 136 (e.g., signal phase-based adjustments) and the IMU 140 (position, velocity, orientation, etc.). The camera(s) 144 are used to capture images (e.g., in front of the vehicle 100), which are used to detect the roadway (e.g., lane lines) and other objects (road signs, flashing lights, etc.). While visual/image cameras are primarily described herein, it will be appreciated that the term “camera” as used herein comprises any suitable type of camera, including infrared (IR) or night-vision cameras.

The LIDAR system 148 and the RADAR system 152 are similarly used for detecting nearby objects based on transmitted/reflected light and radio wave pulses. The HD map system 148 routinely caches (e.g., stores in memory) and updates this HD map data via the network. During a long period of driving, multiple update/cache cycles could be performed. When the network is unavailable, the locally stored HD map data could be utilized. The traffic services system 160 also receives (e.g., via the network) traffic information indicative of temporary traffic and/or weather evacuation conditions where wrong way travel would be temporarily acceptable.

Referring now to FIG. 3 and with continued reference to FIGS. 1A-1C, a flow diagram of an example vehicle wrong way travel and detection method 300 according to the principles of the present disclosure is illustrated. While the method 300 is described with respect to the vehicle 100 and its components as illustrated in FIG. 2 and described above, it will be appreciated that the method 300 could be applicable to any suitable vehicle having the appropriate componentry. At 304, the controller 112 receives information from at least some of the plurality of perception sensors 128 indicative of a position of the vehicle 100 relative to its environment. At 308, the controller 112 receives HD map data. This information received at 304 and 308 is collectively referred to as first information.

At optional 312, the controller 112 could also receive second information from the traffic services system 160 indicative of existing construction or weather evacuation conditions that could affect whether wrong way travel is temporarily acceptable. At 316, the controller 112 generates a confidence score indicative of a likelihood that the vehicle 100 is traveling in a wrong direction along a roadway using a vehicle position model, the first information, and optionally using the second information. As previously discussed herein, the combination of the HD map data and the data perceived by the suite of perception sensors 128 allows for very precise localization of the position of the vehicle 100 with respect to the HD map data. In addition, because the HD map data is very detailed, including defining specific lane lines, the vehicle position model is capable of determining with a very high degree of accuracy the vehicle position and thus the likelihood that the vehicle 100 is traveling in a wrong direction.

It will be appreciated that the vehicle position model could be any suitable machine learning model or algorithm (e.g., a neural network-based model) that is trained over time (using training data, vehicle-to-vehicle data sharing, etc.) to further enhance its accuracy/performance. One example output of the vehicle position model is a percentage indicative of a likelihood that the vehicle 100 is traveling in the wrong direction. As previously discussed, some factors, such as existing construction or weather evacuation conditions as indicated by the traffic services system 160, could greatly lower the confidence score generated by the vehicle position model such that it would be determined that the vehicle was not traveling in a wrong direction. For example, during a weather evacuation (e.g., hurricane evacuation) or any other suitable evacuation scenario (e.g., other declared emergencies or disasters), some roadways may be temporarily changed from two-way roads to one-way roads in order to expedite the flow of traffic from an area.

In FIG. 1A, for example, both sides of the FOW 1 road (e.g., a highway) could temporarily have vehicles traveling in the same direction, which could also involve vehicles entering the FOW 1 road via FOW 10 road portions (e.g., exit or off-ramps). In FIG. 1B, for example, both sides of the FOW 2 road (e.g., a divided road) could temporarily have vehicles traveling in the same direction. In FIG. 1C, for example, both sides of the FOW 3 road (e.g., a two-lane road) could temporarily have vehicles traveling in the same direction. The same applies to construction scenarios, where some lanes of roadways are temporarily closed or traffic is otherwise temporarily diverted. In FIG. 1B, for example, one side of the FOW 2 road could temporarily have vehicles traveling in opposing directions (e.g., in neighboring lanes) while the other side of the FOW 2 road is temporarily closed for construction. In FIG. 1C, for example, one side of the FOW 3 road could temporarily alternate between vehicles traveling in opposing directions in one of the two lanes while the other lane is temporarily closed for construction.

At 320, the controller 112 compares the confidence score to one or more thresholds. When a confidence score threshold is satisfied, the method 300 proceeds to 324 where the controller 112 controls one or more operating parameters of the vehicle 100 to prevent, mitigate, or remedy any wrong way travel. Otherwise, the method 300 ends or returns to 304. In one exemplary implementation, the confidence score is compared to a single threshold indicative of an acceptable likelihood that the vehicle 100 is traveling in a wrong direction. This could be a relatively high confidence score, such as 95+%.

In other implementations, different confidence scores could be utilized to provide different levels or degrees of control of one or more operating parameters of the vehicle 100. For example, higher confidence score thresholds could be associated with more intense or aggressive vehicle parameter control, such as driver alerts being provided when lesser confidence score thresholds are satisfied versus vehicle take-over (e.g., automated steering/braking or full vehicle shut-down at vehicle stop) when higher confidence score thresholds are satisfied. At optional 328, the controller 112 determines whether wrong way travel continues (e.g., by repeating the previous information gathering and confidence score modeling/comparing of 304-320) after the initial controlling of the one or more operating parameters. When true, the method 300 proceeds to optional 332. Otherwise, the method 300 ends or returns to 304. At 332, the controller 112 increases the intensity or aggressiveness of the control of the one or more operating parameters. For example, a driver alert could have been initially provided but was insufficient, so vehicle take-over (e.g., automated steering/braking or full vehicle shut-down at vehicle stop) could subsequently occur.

It will be appreciated that while mitigation and remedying of detecting vehicle wrong way driving is primarily described herein (i.e., vehicle operating control after wrong way travel has been detected), the techniques of the present disclosure could be applied in a proactive or predictive manner such that the wrong way travel could be prevented by vehicle operating control. For example, the vehicle position model could generate a confidence score that satisfies a threshold when it is highly likely that the vehicle is about to begin a wrong way driving scenario. In such cases, the wrong way driving scenario could be avoided entirely and thus prevented by controlling the one or more vehicle operating parameters. For example only, the steering wheel could be fully turned such that forward movement would cause the vehicle to turn against the prescribed or legal flow of traffic. Once the vehicle begins forward movement, the vehicle position model could generate a confidence score that satisfies a threshold (e.g., a driver alert or automated steering/braking). This control could be sufficient to fully prevent the wrong way driving scenario before it actually begins.

As previously discussed, it will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A wrong way travel detection and control system for a vehicle, the system comprising:
a set of perception sensor systems each configured to perceive a position of the vehicle relative to its environment;
a map system configured to maintain map data; and
a controller configured to:
receive first information from the set of perception sensor systems and the map system;
generate a confidence score indicative of a likelihood that the vehicle is traveling in a wrong direction along a roadway using a vehicle position model and the received first information;
compare the confidence score to a set of one or more thresholds; and
based on the comparing, selectively control one or more operating parameters of the vehicle to remedy the wrong direction travel of the vehicle.

2. The system of claim 1, wherein the controller is further configured to:
receive second information from a traffic services system indicative of a traffic or weather evacuation status of the roadway, and
generate the confidence score using the vehicle position model and the received first and second information.

3. The system of claim 2, wherein the vehicle position model is trained to determine an acceptable wrong way driving scenario when the second information indicates temporarily acceptable wrong way travel.

4. The system of claim 1, wherein the one or more thresholds each correspond to a different level or degree of the control of the one or more operating parameters of the vehicle.

5. The system of claim 4, wherein the controller is further configured to increase the level or degree of control of the one or more operating parameters of the vehicle while the wrong direction of travel of the vehicle continues.

6. The system of claim 1, wherein the one or more operating parameters of the vehicle include (i) at least one of audible, visual, and haptic driver notifications, (ii) at least one of automated steering and braking of the vehicle, and (iii) full shutdown of the vehicle.

7. The system of claim 1, wherein the set of perception sensors comprises at least one of a global navigation satellite system (GNSS) receiver, a real-time kinematic (RTK) system, an inertial measurement unit (IMU), a camera system, a light detection and ranging (LIDAR) system, and a radio detection and ranging (RADAR) system.

8. The system of claim 1, wherein the set of perception sensors comprises a global navigation satellite system (GNSS) receiver, a real-time kinematic (RTK) system, an inertial measurement unit (IMU), a camera system, a light detection and ranging (LIDAR) system, and a radio detection and ranging (RADAR) system.

9. A wrong way travel detection and control method for a vehicle, the method comprising:
receiving, by a controller of the vehicle, first information comprising:
a perceived position of the vehicle relative to its environment from each of a set of perception sensor systems; and
map data from and maintained by a map system;
generating, by the controller, a confidence score indicative of a likelihood that the vehicle is traveling in a wrong direction along a roadway using a vehicle position model and the received first information;
comparing, by the controller, the confidence score to a set of one or more thresholds; and
based on the comparing, selectively controlling, by the controller, one or more operating parameters of the vehicle to remedy the wrong direction travel of the vehicle.

10. The method of claim 9, further comprising:
receiving, by the controller, second information from a traffic services system indicative of a traffic or weather evacuation status of the roadway, and
generating, by the controller, the confidence score using the vehicle position model and the received first and second information.

11. The method of claim 10, wherein the vehicle position model is trained to determine an acceptable wrong way driving scenario when the second information indicates temporarily acceptable wrong way travel.

12. The method of claim 9, wherein the one or more thresholds each correspond to a different level or degree of the control of the one or more operating parameters of the vehicle.

13. The method of claim 12, further comprising increasing, by the controller, the level or degree of control of the one or more operating parameters of the vehicle while the wrong direction of travel of the vehicle continues.

14. The method of claim 9, wherein the one or more operating parameters of the vehicle include (i) at least one of audible, visual, and haptic driver notifications, (ii) at least one of automated steering and braking of the vehicle, and (iii) full shutdown of the vehicle.

15. The system of claim 9, wherein the set of perception sensors comprises at least one of a global navigation satellite system (GNSS) receiver, a real-time kinematic (RTK) system, an inertial measurement unit (IMU), a camera system, a light detection and ranging (LIDAR) system, and a radio detection and ranging (RADAR) system.

16. The method of claim 9, wherein the set of perception sensors comprises a global navigation satellite system (GNSS) receiver, a real-time kinematic (RTK) system, an inertial measurement unit (IMU), a camera system, a light detection and ranging (LIDAR) system, and a radio detection and ranging (RADAR) system.
